(19) United States
(12) Patent Application Publication
(10) Pub. No.: US 2006/0150631 A1
(43) Pub. Date: Jul. 13, 2006

(54) LIQUID FUEL RECIRCULATION SYSTEM AND METHOD

(75) Inventors: David William Smith, Simpsonville, SC (US); Steve William Backman, Simpsonville, SC (US); Kevin Lee Kunkle, Simpsonville, SC (US); David John Chrisfield, Greenville, SC (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/905,564

(22) Filed: Jan. 11, 2005

(51) Int. Cl. F02C 7/22

(52) U.S. Cl. 60/772; 60/734

(57) ABSTRACT

A recirculation system for circulating distillate during gas fuel operation so as to reduce or eliminate distillate carbon formation. The recirculation system keeps the distillate's temperature below the carbon formation limit by circulating the distillate back to a storage tank to cool the distillate due to a volume of the storage tank compared to the volume of the recirculation system. The recirculating flow also exercises the flow dividers' gears without having to perform fuel transfers. Further, the system evacuates air from the liquid fuel lines to further decrease the likelihood of carbonaceous residue forming on any interior surfaces that are actually exposed to distillate.

### BACKGROUND OF THE INVENTION

In dual-fuel gas turbines, the turbine operates by burning either a gaseous fuel or a liquid fuel, the latter fuel typically being distillate oil. These gas turbines have fuel supply systems for both liquid and gas fuels. The gas turbines generally do not burn both gas and liquid fuels at the same time. Rather, when the gas turbine burns liquid fuel, the gas fuel supply is turned off, and when the gas turbine burns gaseous fuel, the liquid fuel supply is turned off.

In an exemplary industrial gas turbine, the combustor may have an array of combustion cans, each of which has a liquid fuel nozzle and a gas fuel nozzle. In the combustion can arrangement, combustion is initiated within the combustion cans at a point slightly downstream of the nozzles. Air from the compressor flows around and through the combustion cans to provide oxygen for combustion. Water injection nozzles are arranged within the combustor to introduce water to the combustion process for the purpose of reducing NOx emissions by reducing the peak flame temperatures.

During distillate operation, liquid fuel systems rely on flow dividers (non-driven gear pumps) to evenly distribute flow to each combustion can. Because gas fuel is used as the primary fuel, liquid fuel systems may remain inoperable for relatively long periods. If the flow dividers are not exercised regularly, they become vulnerable to having their gears bind. Regular exercise for a flow divider is conventionally accomplished during the weekly fuel transfers TIL 1107-3.

Despite the fact that customers are encouraged to exercise their liquid fuel systems at least once a week, this recommendation is not always heeded. In some instances, customers have valid causes for not following this recommendation. Reasons for not periodically running the liquid fuel systems may include reliability issues, emissions concerns and an unwillingness to decrease loads simply to transfer fuels, especially when power is trading favorably.

Existing F-Class gas turbines that have dual fuel capacity (gas fuel as primary and distillate as backup) are susceptible to carbon deposits forming in the liquid fuel system. Research indicates that carbon formation begins when distillate is heated to a temperature of 350° F. in the absence of oxygen. In the presence of oxygen, the process accelerates and carbon formation begins at approximately 200° F. As carbon deposits accumulate, they effectively reduce the cross-sectional passages through which the liquid fuel flows. If the carbon deposition continues, particles may clog the distillate passages. Since the carbon particles may not be present upstream of the turbine compartment, minimum passage sizes are not an issue until the distillate has been subjected to the turbine compartment's heat.

When burning gas fuel the fuel nozzle liquid passages are purged but liquid fuel remains in the system up to the three-way purge valve ready for an immediate fuel transfer. The gas fuel passages are purged when burning liquid fuel.

Differential pressures in the distillate and purge air lines serve to actuate three-way valves disposed between the flow dividers and the cans. When a turbine is operating on gas fuel, purge air, which runs at a higher pressure than the static liquid fuel system pressure during gas fuel operation, actuates the three-way valves such that distillate cannot enter any of the combustion cans. During liquid fuel operation, the fuel pump pressurizes the distillate so that its force is greater than that of the purge air. As a result, the piston within the three-way valve slides over to block the purge air flow and allow distillate into the combustion cans.

When a turbine is operating on gas fuel, as noted above, the liquid fuel system remains charged so that it is readily available for any fuel transfer requests. When liquid fuel systems remain inoperable beyond the recommended time limit, there is an increased likelihood that the static distillate within the turbine compartment will begin to experience carbon formation. Furthermore, due to the large difference in pressures, purge air often seeps across seals within the three-way valve's internal cavities. Air then comes into intimate contact with distillate on the other actuating side of the three-way valve. As noted above, distillate carbon formation initiates at a much lower temperature in the presence of oxygen. Considering that F-Class turbine compartment temperatures have been measured in excess of 315° F., carbon formation is even more likely to occur if the seeping purge air remains in contact with static distillate. As carbonaceous particles form, they pose the threat of clogging internal flow passages, which could result in a turbine trip while switching to liquid fuel operation.

Prior actions to prevent carbon formation include methods for dissipating heat from the turbine compartment, which have primarily focused on ventilating the surrounding air, and efforts to exercise the system to help prevent gear binding in flow dividers, as mentioned above.

FIG. 1 is a simplified schematic depicting the existing or conventional liquid fuel system. This particular schematic illustration is of the configuration associated with F-Class GE Gas Turbines. As illustrated, the liquid fuel system begins downstream of the fuel forwarding system. Thus, the liquid fuel flows into the current liquid fuel system configuration from the liquid fuel forwarding skid as illustrated at 10. During liquid fuel operation, fuel forwarding pumps provide distillate flow through the LP filters and to the inlet of the fuel pump 12. The fuel pump 12 creates positive distillate flow through the bypass control valve 16 and the stop valve 18. FIG. 1 corresponds to a turbine firing on natural gas with the distillate on stand-by. For that reason, the bypass control valve 16 and stop valve 18 are disposed to recirculate any distillate flow through respective bypass lines 20, 22 to recirculation line 24. When the system is operating on liquid fuel, a portion is diverted to the flow divider 26 which evenly distributes flow to each combustion can 28, only one of which is illustrated in FIG. 1. Box 30 schematically illustrates the turbine compartment and the components that are contained within this compartment.

When a turbine is operating on gas fuel, as illustrated in FIG. 1, the liquid fuel system remains charged so that it is readily available for any fuel transfer request. But, system components sit idle while both control and stop valves 16, 18 remain seated in their normally closed position. Purge air, which runs at a higher pressure than the static liquid fuel system pressure during gas fuel operation, actuates the three-way valve 32 associated with each combustor (only one of which is illustrated in FIG. 1) so that distillate cannot enter the respective combustion can 28. It is this same purge air, that actuates the three-way valve 32, that can seep past the seals in the three way valve, interact with distillate, and promote carbon formation.

### BRIEF DESCRIPTION OF THE INVENTION

Exemplary embodiments of the present invention provide a recirculation system for circulating distillate during gas fuel operation so as to reduce or eliminate distillate carbon formation. Adding a recirculation system embodying the invention offers multiple benefits. First, it keeps the distillate's temperature below the carbon formation limit by circulating the distillate back to a heat sink. Second, the recirculating flow exercises the flow dividers' gears without having to perform fuel transfers. Third, the system of the invention evacuates air from internal cavities around the three-way valves, which are the areas most likely to be exposed to air (oxygen) due to their operational nature.

Exemplary embodiments of the present invention are thus intended to obsolesce the suggested practice that customers perform fuel transfers in order to exercise their liquid fuel systems. In addition to relaxing the recommendation for a periodic operation of the liquid fuel system, the recirculation system offers the benefit of increased reliability and availability.

Exemplary embodiments of present invention are thus embodied in a liquid fuel recirculation system for recirculating liquid fuel during gas fuel operation of a dual fuel gas-turbine, comprising: a valve for selectively directing liquid fuel to a liquid fuel nozzle of the turbine; a liquid fuel storage tank; a fuel forwarding pump for pumping liquid fuel to the valve; a recirculation line for recirculating liquid fuel from the valve back to the liquid fuel storage tank to be cooled and fresh cooled liquid fuel from the liquid fuel storage tank is pumped to the valve via the fuel forwarding pump in an open loop recirculation system; and a source of liquid fuel purge air operatively coupled to the valve; wherein the valve is constructed and arranged to shuttle between a liquid fuel mode wherein liquid fuel is directed to the liquid fuel nozzle, and a purge mode wherein liquid fuel is directed to the recirculation line and purge air from the purge air source is directed to the liquid fuel nozzle.

Exemplary embodiments of the present invention may also be embodied in a system for recirculating liquid fuel during gas fuel operation of a dual fuel gas-turbine, comprising: a plurality of three-way valves, each for receiving liquid fuel from a liquid fuel flow divider and selectively directing the liquid fuel to a respective combustion can of the turbine; a liquid fuel storage tank; a fuel forwarding liquid fuel pump for selectively pumping liquid fuel through the flow divider to the three-way valves; a plurality of recirculation lines, each for recirculating liquid fuel from a respective the three-way valve to a recirculating flow manifold; a common recirculating flow line for conducting liquid fuel from the manifold back to the liquid fuel storage tank to be cooled and fresh cooled liquid fuel from the liquid fuel storage tank is pumped to the valve via the fuel forwarding liquid fuel pump in an open loop recirculation system; and a source of liquid fuel purge air operatively coupled to each the three-way valve; wherein the three-way valves are constructed and arranged to shuttle between a liquid fuel mode wherein liquid fuel is directed to the combustion can, and a purge mode wherein liquid fuel is directed to the respective recirculation line and purge air from the purge air source is directed to the combustion can.

Exemplary embodiments of the present invention also provide a method of reducing distillate carbon formation in a liquid fuel supply system during gas fuel operation of a dual fuel gas turbine comprising: providing a valve for selectively directing liquid fuel from a liquid fuel storage tank to a liquid fuel nozzle of the turbine; providing a recirculation line for recirculating liquid fuel from the valve back to the liquid fuel storage tank; communicating a source of liquid fuel purge air with the valve, wherein the valve is constructed and arranged to shuttle between a liquid fuel mode wherein liquid fuel is directed to the liquid fuel nozzle, and a purge mode wherein liquid fuel is directed to the recirculation line and purge air from the purge air source is directed to the liquid fuel nozzle; actuating the valve to the purge mode; operating a fuel forwarding liquid fuel pump to direct liquid fuel to the valve; and recirculating the liquid fuel to the liquid fuel storage tank to be cooled and fresh cooled liquid fuel from the liquid fuel storage tank is pumped to the valve via the fuel forwarding liquid fuel pump through the recirculation line in an open loop recirculation system.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a schematic illustration of a conventional liquid fuel system; and

FIG. 2 is a schematic illustration of a liquid fuel system having recirculation lines as an embodiment of the invention.

The following description of the figures is not intended to be, and should not be interpreted to be, limiting in any way.

### DETAILED DESCRIPTION OF THE INVENTION

As noted above, hot temperatures in the turbine compartment lead to carbon formation in stagnant fuel lines. Carbon formation results in valve malfunctioning and/or nozzle plugging, which in turn causes excessive trips during fuel transfers, liquid fuel startups and liquid fuel operations. Fuel data indicates that if the tubing wall temperatures of the fuel oil system are held below 200° F. then carbon formation will be minimized.

As will be described herein below, the liquid fuel recirculation system embodying the invention provides a number of functions. First, the system keeps the liquid fuel wetted wall temperature below 200° F. The system further maintains continuous operation of the system and prevents the settling of air and water that causes corrosion and subsequent binding of the gears in the flow divider. The fuel recirculation system also minimizes air entrapment/infiltration into the system.

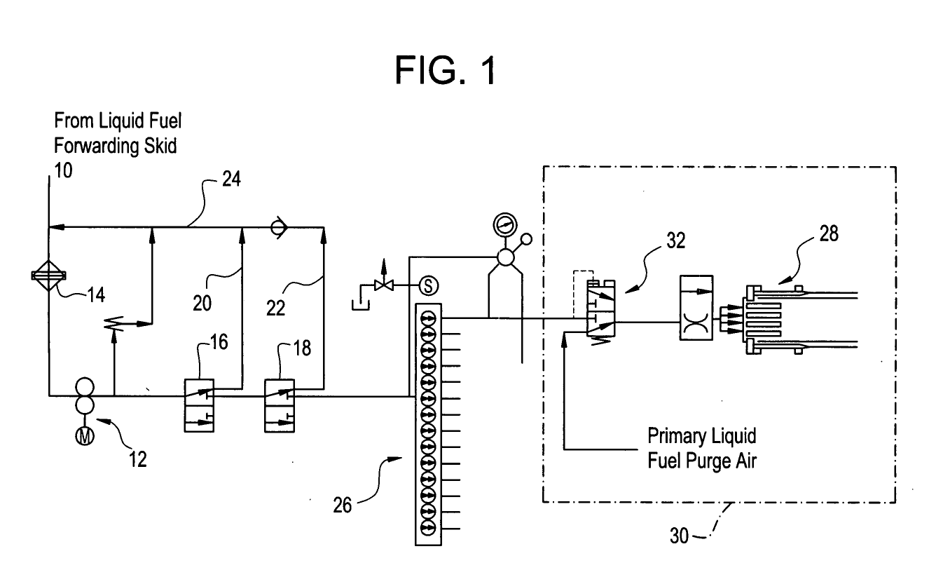

As noted above, FIG. 1 is a schematic illustration of an exemplary conventional liquid fuel system. This particular schematic illustrates the configuration associated with F-Class General Electric gas turbines. This liquid fuel system begins downstream of the fuel forwarding system and continues through the current components to each of the turbines individual combustion cans. FIG. 1 configuration corresponds with the turbine firing all natural gas (distillate on standby).

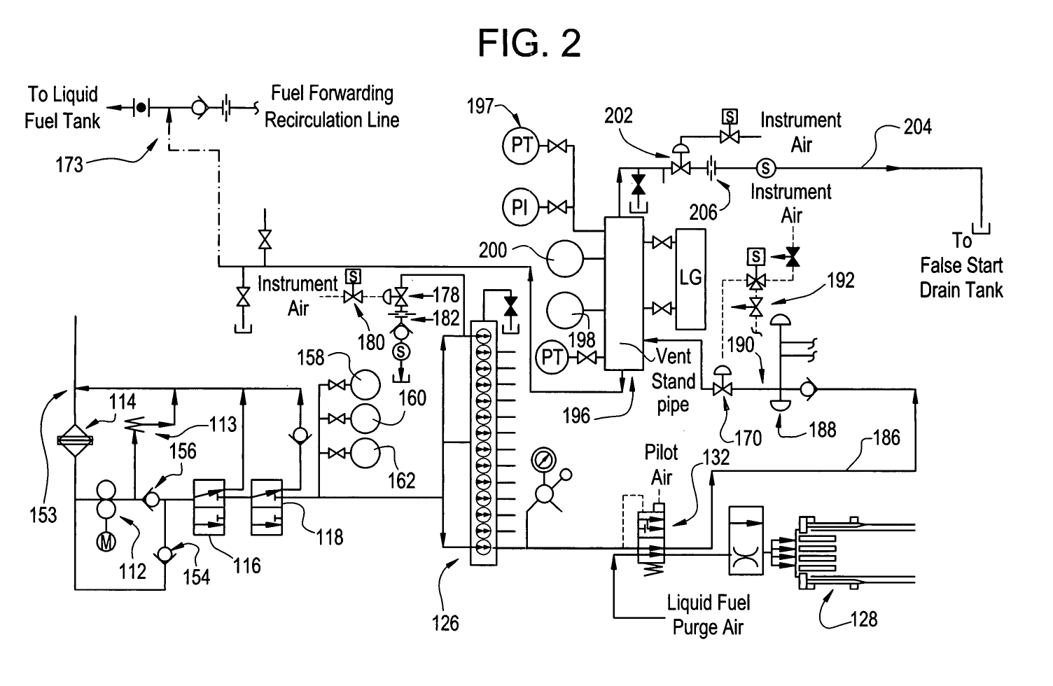

The recirculation system embodying the invention does not modify the operation of the existing liquid fuel system, but rather is an overlay thereto. A liquid fuel system with recirculation embodying the invention is schematically illustrated in FIG. 2.

It should be noted that as illustrated in FIG. 1, during gas fuel operation using the conventional configuration, both the stop valve 18 and control valve 16 are in their normally closed position. According to the recirculation system schematically illustrated in FIG. 2, the control valve 116 and stop valve 118, which are illustrated in their closed position, are actuated open when the turbine is firing and has reached 95% of full speed. This coincides with starting the recirculation system in an exemplary implementation of the invention, as explained in greater detail below.

When liquid fuel pressure exceeds purge pressure, the three-way valve spool 132 will start to shuttle and will eventually cut off purge flow. Accordingly, the liquid fuel pressure during liquid fuel recirculation should be kept sufficiently low so as not to affect the operation of the purge system while flame is present in the gas turbine. In a typical system, the liquid fuel pressure must be kept less than about 80 psid above purge pressure, or the three-way valve spool will start to shuttle. In an exemplary embodiment of the invention, so that if the three-way valve leaks, the purge air will leak into the liquid fuel system rather than the liquid fuel leaking in to the nozzle. Pressure transducers 158, 160, 162 are a part of the pressure release system associated with the three-way valves 132 and are shown in the illustrated embodiment for completeness. In this regard it should be noted that the three transducer relief system is not part of the recirculation system per se, but is a part of an exemplary standard system and are provided because of the three-way valves, not the recirculation system. The transducers 158, 160, 162 are provided to monitor the pressure of the liquid fuel system. Multiple transducers are provided for redundancy so that the failure of one instrument does not cause an unnecessary trip of the gas turbine. In the illustrated embodiment, block valves are provided around the transducers 158,160,162 so that the transducers 158,160,162 can be isolated while the system is on line.

Pressure relief valve 178 is part of the pressure relief system associated with the three-way valve 132 and is shown here for completeness. Valve 178 operates based on the signal from pressure transducers 158, 160, 162. In an exemplary embodiment, valve 178 is adapted to open if the liquid fuel pressure is greater than or equal to, e.g., about 5 psig above compressor discharge pressure (Pcd), when operating on gas fuel, and to close if the liquid fuel pressure is less than, e.g., about 5 psid below Pcd, when operating on gas fuel. This is appropriate to ensure that nozzle tips are not damaged due to lack of purge on the one hand and to ensure the liquid fuel pressure does not get too low on the other hand, which may result in excessive leakage of purge air into the liquid fuel system, if the three-way valve 132 leaks. Valve 178 is actuated by instrument air and a solenoid valve 180 controls the instrument air to valve 178. In the illustrated embodiment, an orifice 182 is located downstream of pressure relief valve 178 so that when the valve is open an excess flow rate will not leave the system. In an embodiment of the invention, pressure relief valve 178 taps off a high point in the liquid fuel system. Thus, in the illustrated embodiment, valve 178 is placed at the inlet connection to the flow divider 126. In this way, the pressure relief valve can serve a dual purpose of removing air from the liquid fuel system. A timer (not shown) may be provided to periodically open valve 178 to remove air from the system.

The individual recirculation lines 186 tie together at a common manifold 188. This simplifies the tie-in process by combining, e.g., lines 186, into a common line 190. Shut off valve 170, mentioned above, is provided to shut off the recirculation flow during periods when recirculation is not required, such as when the turbine is down. In the illustrated embodiment, valve 170 is actuated by instrument air and a solenoid valve 192 controls the instrument air to that valve.

Heat gained while circulating through the compartment is dissipated in the main storage tank due to its volume in relation to the recirculation system volume. In accordance with this alternative, existing distillate supply systems are out fed with the recirculation lines from the fuel forward system to the main storage tank. Tying into the lines running from the fuel forwarding skid to the tank as at 173 provides a means for the circulating distillate to complete the loop.

According to a further aspect of the invention, the recirculation lines 186 slope up generally continuously to the recirculation manifold 188. In this way, any air that leaks past the three-way valves 132 will rise up to the vent standpipe 196 and can be removed from the system. The vent standpipe is the high point of the system to ensure that any air in the system will ultimately end up in the standpipe for removal.

In an exemplary embodiment, the standpipe has a low level switch 198 and a high level switch 200. Opening and closing of a vent valve 202 can then be based on the level switches, such that when the fuel in the vent standpipe reaches the high level switch, the vent valve 202 is closed and when the fuel level in the vent standpipe drops, due to the accumulation of air, to the low level sensor 198, the vent valve 202 is opened. In addition or in the alternative, a plurality of transducers 197 may be placed on the standpipe to provide a substantially continuous level measurement to aid in trouble shooting. Moreover, in the event of a failure of level switches 198, 200, the transducers may then be used as the main level system and can control the opening and closing of valve 202.

In the illustrated embodiment, the vent line 204 is directed to the false start drain tank. This is provided so that if liquid fuel is inadvertently vented, it drains to a vessel that is designed to accept liquid fuel. In the illustrated embodiment, an orifice 206 is placed in the vent line 204 to control the vent rate.

Valve 202 is typically adapted only to open when a threshold pressure is present in the standpipe as would be detected by the pressure transducer(s) 197. This ensures that only the standpipe vents and does not undesirably pull air from the false start drain tank. Normally, the vent standpipe is designed to be used only when running the recirculation system. However, functionality can be built in that will enable valve 202 to be used to vent accumulated air even though the recirculation system is not running.

Some pressure relief system requirements are shown in the illustrated embodiments for completeness. The system may be adapted to alarm if the liquid fuel pressure exceeds a certain valve above Pcd for a prescribed period of time to signify, e.g., that there is problem with the pressure relief system. Likewise, the system may be adapted to alarm if the liquid fuel pressure is less than a predetermined pressure below Pcd, also to signify that there is a problem with the pressure relief system.

The system may also trip the turbine if the liquid fuel pressure exceeds a particular value above Pcd for longer than a predetermined period when operating on gas fuel, in order to protect the fuel nozzles from possible damage due to lack of purge. Alarms(s) may also sound if one or more valves are open, or closed, for more than a predetermined period. For example, the system may alarm if valve 202 is open for greater than a particular period or open more than a predetermined number of times during a prescribed period, as this may indicate, for example, that there is three-way valve leak and/or that the standpipe is not venting properly.

Determination of the proper distillate flow rate through the recirculation system is advantageously based on upon selection of the maximum value among the limiting cases. Two system sizing cases were evaluated to establish the minimum recirculation rate: 1) flow required to dissipate heat gained from the turbine compartment; and 2) flow specified in the vendor data for proper operation of the recirculation port on the required three-way valve. Between the two options, flow through the three-way valve recirculation port represented the higher value. Selecting the higher value, approximately 28 gpm, ensured that the other scenario would be addressed as well.

Recirculating fuel flows through the flow divider 126 ensuring that equal liquid fuel flow rates go to each combustor. Thus, the recirculation system does not inhibit the functionality of the flow divider 126.

In general when running on liquid fuel, no air should be in the liquid fuel system so that valve 202 can stay closed when operating on liquid fuel. However, the system can be adapted to override, for example, when air is likely to be introduced into the system. This will most probably occur when transferring to liquid fuel if the forwarding pumps have been shut down while operating on gas fuel.

The system turns on at about 95% speed in order to simplify sequencing. Likewise, during a shutdown, the recirculation system turns off at about 95% speed, again to simplify the sequencing. After a shutdown, the recirculation system does not need to run as the compartment temperatures are below the carbon formation temperature.

As mentioned above, the flow divider must be exercised to prevent gear binding. Recirculating liquid fuel with the system described herein effectively exercises the flow divider. The flow divider can also be exercised via fuel transfers rather than a continual flow. However, liquid to gas transfers must be performed at reduced loads, which reduces revenue and may result in temporary operation with out emissions compliance.

In addition to rejecting heat gained from the compartment, removing air from the liquid fuel lines further decreases the likelihood of carbonaceous residue forming on any interior surfaces that are exposed to distillate. In an exemplary embodiment of the invention, recirculation tubing lines that discharge from the three-way valves are arranged to flow up towards the roof of turbine compartment. Utilizing this configuration evacuates purge air that might seep back through the three-way valves and mix with distillate.

As mentioned above, air (oxygen) accelerates carbon formation. In addition, during liquid fuel operations, air pockets disrupt smooth delivery of liquid fuel. The recirculation system embodying the invention prevents air pockets from forming in the liquid fuel tubing to ensure smooth delivery of liquid fuel and decelerate carbon formation.

While the methods and apparatus described above and/or claimed herein are described above with reference to an exemplary embodiment, it will be understood by those skilled in the art that various changes may be made and equivalence may be substituted for elements thereof without departing from the scope of the methods and apparatus described above and/or claimed herein. In addition, many modifications may be made to the teachings of above to adapt to a particular situation without departing from the scope thereof. Therefore, it is intended that the methods and apparatus described above and/or claimed herein not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A liquid fuel recirculation system for recirculating liquid fuel during gas fuel operation of a dual fuel gas-turbine, comprising:
a valve for selectively directing liquid fuel to a liquid fuel nozzle of the turbine;
a liquid fuel storage tank;
a fuel forwarding pump for pumping liquid fuel to said valve;
a recirculation line for recirculating liquid fuel from said valve back to said liquid fuel storage tank to be cooled and fresh cooled liquid fuel from said liquid fuel storage tank is pumped to said valve via said fuel forwarding pump in an open loop recirculation system; and
a source of liquid fuel purge air operatively coupled to said valve;
wherein said valve is constructed and arranged to shuttle between a liquid fuel mode wherein liquid fuel is directed to said liquid fuel nozzle, and a purge mode wherein liquid fuel is directed to said recirculation line and purge air from said purge air source is directed to said liquid fuel nozzle.

2. The liquid fuel recirculation system as in claim 1, wherein there are a plurality of said liquid fuel nozzles, and a plurality of said valves one valve being operatively coupled to each said liquid fuel nozzle, and further comprising a flow divider for dividing flow from said at least one pump to said valves, and further wherein there are a plurality of said recirculation lines, one recirculation line recirculating liquid fuel from each said valve, the plurality of recirculation lines terminating at a manifold for tying in the recirculation flows to a common flow line that flows to one of said liquid fuel storage tank and said at least one pump.

3. The liquid fuel recirculation system as in claim 2, wherein each said recirculation line is inclined upward to facilitate airflow towards said manifold.

4. The liquid fuel recirculation system as in claim 1, further comprising a vertical vent pipe in flow communication with said recirculation line for collecting air for venting from the recirculation system.

5. The liquid fuel recirculation system as in claim 2, further comprising at least one pressure relief valve tapping off an inlet to said flow divider provided at a high point in the system, whereby said pressure relief valve can be selectively opened to vent air from the system.

6. The liquid fuel recirculation system as in claim 2, wherein said valves are three-way valves.

7. The liquid fuel recirculation system as in claim 1, wherein said valves are three-way valves; and further comprising a bypass passage providing flow communication between a liquid fuel flow line extending between said at least one pump and said three-way valves and said recirculation line.

8. The liquid fuel recirculation system as in claim 1, wherein any heat gained in said liquid fuel while circulating is dissipated in said liquid fuel storage tank due to its volume in relation to a volume of said recirculation system.

9. A system for recirculating liquid fuel during gas fuel operation of a dual fuel gas-turbine, comprising:
a plurality of three-way valves, each for receiving liquid fuel from a liquid fuel flow divider and selectively directing the liquid fuel to a respective combustion can of the turbine;
a liquid fuel storage tank;
a fuel forwarding liquid fuel pump for selectively pumping liquid fuel through said flow divider to said three-way valves;
a plurality of recirculation lines, each for recirculating liquid fuel from a respective said three-way valve to a recirculating flow manifold;
a common recirculating flow line for conducting liquid fuel from said manifold back to said liquid fuel storage tank to be cooled and fresh cooled liquid fuel from said liquid fuel storage tank is pumped to said valve via said fuel forwarding liquid fuel pump in an open loop recirculation system; and
a source of liquid fuel purge air operatively coupled to each said three-way valve;
wherein said three-way valves are constructed and arranged to shuttle between a liquid fuel mode wherein liquid fuel is directed to said combustion can, and a purge mode wherein liquid fuel is directed to said respective recirculation line and purge air from said purge air source is directed to said combustion can.

10. The liquid fuel recirculation system as in claim 9, wherein each said recirculation line is inclined upward to facilitate air flow towards said manifold.

11. The liquid fuel recirculation system as in claim 10, further comprising a vertical vent pipe in flow communication with said common recirculating flow line for collecting air for venting from the recirculation system.

12. The liquid fuel recirculation system as in claim 9, further comprising at least one pressure relief valve tapping off an inlet to said flow divider provided at a high point in the system, whereby said pressure relief valve can be selectively opened to vent air from the system.

13. The liquid fuel recirculation system as in claim 9, further comprising a bypass passage providing flow communication from a liquid fuel flow line extending between said pumps and said flow divider to at least one of (1) said common recirculating flow line and (2) an inlet line to said pumps, and a pressure control valve in said bypass passage for selectively diverting liquid fuel flow to bypass said flow divider.

14. The liquid fuel recirculation system as in claim 9, wherein any heat gained in said liquid fuel while circulating is dissipated in said liquid fuel storage tank due to its volume in relation to a volume of said recirculation system.

15. A method of reducing distillate carbon formation in a liquid fuel supply system during gas fuel operation of a dual fuel gas turbine comprising:
providing a valve for selectively directing liquid fuel from a liquid fuel storage tank to a liquid fuel nozzle of the turbine;
providing a recirculation line for recirculating liquid fuel from said valve back to said liquid fuel storage tank;
communicating a source of liquid fuel purge air with said valve, wherein said valve is constructed and arranged to shuttle between a liquid fuel mode wherein liquid fuel is directed to said liquid fuel nozzle, and a purge mode wherein liquid fuel is directed to said recirculation line and purge air from said purge air source is directed to said liquid fuel nozzle;
actuating said valve to said purge mode;
operating a fuel forwarding liquid fuel pump to direct liquid fuel to said valve; and
recirculating said liquid fuel to said liquid fuel storage tank to be cooled and fresh cooled liquid fuel from said liquid fuel storage tank is pumped to said valve via said fuel forwarding liquid fuel pump through said recirculation line in an open loop recirculation system.

16. The method as in claim 15, wherein said step of actuating said valve includes reducing a pressure in the liquid fuel system so that a pressure differential between said purge air and said liquid fuel causes said valve to shuttle to said purge mode.

17. The method as in claim 13, wherein said step of providing a recirculation line comprises providing a recirculation line inclined upwardly from said valve for directing air from said valve and in said recirculation line to flow to and collect at a high point in the system.

18. The method as in claim 17, further comprising collecting air from said recirculation line in a standpipe and further comprising selectively venting said collected air.

19. The method as in claim 15, further comprising providing a bypass passage to provide flow communication from a liquid fuel flow line extending between said at least one pump and said valve to at least one of (1) said liquid fuel storage tank and (2) said at least one pump, a pressure control valve in said bypass passage selectively diverting liquid fuel flow to bypass said valve.

20. The method as in claim 15, wherein any heat gained in said liquid fuel while circulating is dissipated in said liquid fuel storage tank due to its volume in relation to a volume of said recirculation system.
